(19) United States
(12) Patent Application Publication
(10) Pub. No.: US 2026/0180981 A1
(43) Pub. Date: Jun. 25, 2026

(54) METHODS AND DEVICES FOR TRANSMITTING A HIDDEN IDENTITY

(71) Applicant: Capital One Services, LLC, McLean, VA (US)

(72) Inventors: Jeffrey RULE, Chevy Chase, MD (US); Lawrence DOUGLAS, McLean, VA (US); Paul Young MORETON, Glen Allen, VA (US)

(21) Appl. No.: 18/987,756

(22) Filed: Dec. 19, 2024

(51) Int. Cl. H04L 9/40; G06Q 40/08

(52) U.S. Cl. CPC H04L 63/0853; H04L 63/0428; G06Q 40/08

(57) ABSTRACT

Methods and devices for transmitting a hidden identity are disclosed. An application executing on a processor of a first computing device associated with a first account receives, from a contactless card associated with a second account, an encrypted payload including identifying information of a second account. The application sends the encrypted payload to a server for authentication of the second account. The application receives verification of the second account and confirmation that the identifying information of the second account has been stored in association with a record of an event.

### BACKGROUND

Providing personal information, including identifying information, is necessary for certain situations, such as to another driver following an automobile collision. However, an automobile collision can cause a hostile environment between the involved drivers and, accordingly, they may not want to share certain identifying information, such as a name or address, with the other driver when exchanging the necessary automobile insurance information. There is a need to provide users with a secure way of providing identifying information to others that can be verified for the recipients without being disclosed to the recipients.

### SUMMARY

The described subject matter relates to methods, devices, and systems for transmitting a hidden identity. An example method includes receiving, by an application executing on a processor of a first computing device associated with a first account and from a contactless card associated with a second account, an encrypted payload including identifying information of a second account. The method further includes sending, by the application, the encrypted payload to a server for authentication of the second account. The method further includes receiving, by the application, verification of the second account and confirmation that the identifying information of the second account has been stored in association with a record of an event.

In an aspect of the described method, the server requires a confirmation message from a second computing device associated with the second account before initiating authentication of the second account.

In an aspect of the described method, the second computing device generates the confirmation message in response to tapping the contactless card to the second computing device.

In an aspect of the described subject matter, the method further includes sending, by the application to the server, identifying information of the first account, where the received confirmation from the server includes confirmation that the identifying information of the first account is stored in association with the record of the event.

The method may also include where the first account includes a first automobile insurance account associated with the first computing device, where the second account includes a second automobile insurance account associated with the contactless card.

In an aspect of the described subject matter, the verification of the second account includes verification of the second automobile insurance account, the event includes an automobile collision, and the method further includes receiving, by the application from the server, confirmation that the record of the automobile collision has been filed with an automobile insurance entity associated with the first account based on the identifying information of the first account and the identifying information of the second account.

In an aspect of the described subject matter, the method further includes receiving, by the application from the server, verifying attributes associated with the second account including at least one of a photograph of a driver associated with the second account, a name of the driver associated with the second account, a license plate number of a vehicle associated with the second account, and a make and model of the vehicle associated with the second account.

An example non-transitory computer-readable storage medium includes instructions that when executed by a processor of a first computing device associated with a first account, cause the processor to receive, from a contactless card associated with a second account, an encrypted payload including identifying information of a second account. The instructions further cause the processor to send the encrypted payload to a server for authentication of the second account. The instructions further cause the processor to receive verification of the second account and confirmation that the identifying information of the second account has been stored in association with a record of an event.

In an aspect of the described computer-readable storage medium, the server requires a confirmation message from a second computing device associated with the second account before initiating authentication of the second account.

In an aspect of the described computer-readable storage medium, the second computing device generates the confirmation message in response to tapping the contactless card to the second computing device.

In an aspect of the described computer-readable storage medium, the instructions further cause the processor to send, to the server, identifying information of the first account, where the received confirmation from the server includes confirmation that the identifying information of the first account is stored in association with the record of the event.

In an aspect of the described computer-readable storage medium, the first account includes a first automobile insurance account associated with the first computing device, and the second account includes a second automobile insurance account associated with the contactless card.

In an aspect of the described computer-readable storage medium, the verification of the second account includes verification of the second automobile insurance account, the event includes an automobile collision, and the instructions further cause the processor to receive, from the server, confirmation that the record of the automobile collision has been filed with an automobile insurance entity associated with the first account based on the identifying information of the first account and the identifying information of the second account.

In an aspect of the described computer-readable storage medium, the instructions further cause the processor to receive, from the server, verifying attributes associated with the second account including at least one of a photograph of a driver associated with the second account, a name of the driver associated with the second account, a license plate number of a vehicle associated with the second account, and a make and model of the vehicle associated with the second account.

An example computing device associated with a first account includes a processor and a memory storing instructions that, when executed by the processor, cause the processor to receive, from a contactless card associated with a second account, an encrypted payload includes identifying information of a second account. The instructions further cause the processor to send the encrypted payload to a server for authentication of the second account. The instructions further cause the processor to receive verification of the second account and confirmation that the identifying information of the second account has been stored in association with a record of an event.

In an aspect of the described computing device, the server requires a confirmation message from a second computing device associated with the second account before initiating authentication of the second account.

In an aspect of the described computing device, the second computing device generates the confirmation message in response to tapping the contactless card to the second computing device.

In an aspect of the described computing device, the instructions further cause the processor to send, to the server, identifying information of the first account, where the received confirmation from the server includes confirmation that the identifying information of the first account is stored in association with the record of the event.

In an aspect of the described computing device, the first account includes a first automobile insurance account associated with the first computing device, the second account includes a second automobile insurance account associated with the contactless card, the verification of the second account includes verification of the second automobile insurance account, and the event includes an automobile collision. The instructions further cause the processor to receive, from the server, confirmation that the record of the automobile collision has been filed with an automobile insurance entity associated with the first account based on the identifying information of the first account and the identifying information of the second account.

In an aspect of the described computing device, the instructions further cause the processor to receive, from the server, verifying attributes associated with the second account including at least one of a photograph of a driver associated with the second account, a name of the driver associated with the second account, a license plate number of a vehicle associated with the second account, and a make and model of the vehicle associated with the second account.

### BRIEF DESCRIPTION OF THE SEVERAL VIEWS OF THE DRAWINGS

FIG. 1 illustrates a connection system for transmitting a hidden identity.

FIG. 2 illustrates a connection system for transmitting a hidden identity utilizing a switchboard network.

FIG. 3 illustrates a sequence flow for transmitting a hidden identity.

FIG. 4 is a flow chart of an example method for transmitting a hidden identity conducted by an application executing on a first computing device.

FIG. 5 is a flow chart of an example method for transmitting a hidden identity conducted by a server.

FIG. 6 is a flow chart of an example method for transmitting a hidden identity conducted by a contactless card.

FIG. 7 illustrates a contactless card.

FIG. 8 illustrates contactless card components.

FIG. 9 illustrates an example of a switchboard system configured to operate in accordance with embodiments discussed herein.

FIG. 10 illustrates a flow sequence for a computing device to utilize DNS to resolve and communicate with one or more nodes of a switchboard network.

FIG. 11A illustrates a flow sequence to perform operations between a contactless card and services provided by a client server.

FIG. 11B illustrates a flow sequence to perform operations between a contactless card and services provided by a client server.

FIG. 11C illustrates a flow sequence to perform operations between a contactless card and services provided by a client server.

FIG. 12 illustrates an example message that may be communicated by a contactless card to perform functions described herein.

FIG. 13 is a flow chart of an example method for establishing a session with an issuer device using a switchboard network.

FIG. 14 illustrates a distributed network authentication system.

FIG. 15 is a flow chart illustrating a method performed by a distributed network authentication system.

### DETAILED DESCRIPTION

The systems and methods disclosed herein can provide necessary information about a user while hiding some or all of the information from the recipient. After an automobile collision, it is essential for the drivers to exchange information to submit a claim with their corresponding automobile insurance providers. However, an automobile collision can often cause an uneasy, if not hostile, interaction between the drivers. Naturally, each driver may not want the other driver to know their identity, much less their home address, as would appear on a driver's license that would typically be shared when exchanging the necessary information. Instead of providing a driver's license for the other driver to view and record, a second driver can instead offer a contactless card that has stored the second driver's identifying information including necessary information such as the second driver's automobile insurance information. The contactless card can encrypt the identifying information and send the encrypted information to the first driver's mobile device. An application on the mobile device can receive the encrypted identifying information without having the capability to decrypt and read the identifying information and forward the information to a server for verification. The encrypted identification can be sent with the first driver's identifying information, including the first driver's automobile insurance information, to file a claim with the first driver's automobile insurance provider. This can provide an automatic process for opening a claim for the automobile collision and submitting the identifying information with the automobile insurance information of all drivers involved in the automobile collision. The server receiving the information can be associated with the first driver's automobile insurance provider, or the server can direct the information to the second driver's automobile insurance provider's server based on the other driver's identifying information. The server can initiate an authentication process to verify that the user's automobile insurance coverage is legitimate and send verification to the first driver's application executed on the mobile device.

In some instances, contactless card functions discussed herein may be utilized in a multi-issuer computing environment. These functions may include tap-to functions where a user may tap their contactless card on a device, such as a mobile device, to transmit encrypted information for user verification and for providing pertinent information. The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become highly costly to the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

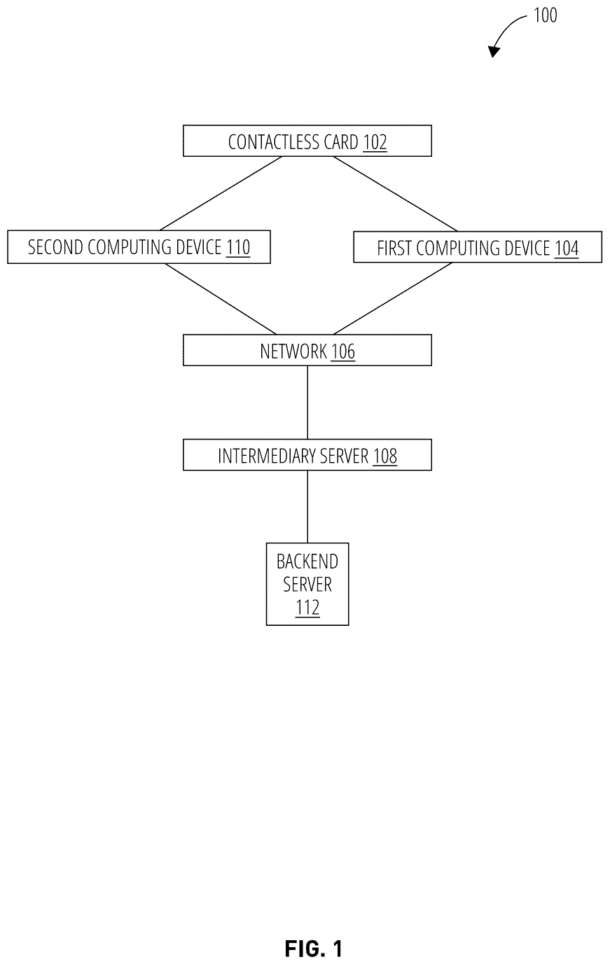

FIG. 1 illustrates a data transmission system 100 according to an example embodiment. As further discussed below, system 100 may include a contactless card 102, first computing device 104, network 106, intermediary server 108, and backend server 112. In some embodiments, system 100 may additionally include a second computing device 110. Although FIG. 1 illustrates single instances of the components, system 100 may include any number of components. System 100 may include one or more contactless cards 102, which are further explained below. Contactless card 102 can communicate identifying information to the first computing device 104 and second computing device 110 via near field communication (NFC), BlueTooth®, Wi-Fi, radio-frequency identification (RFID), or any other suitable protocol. In instances where first computing device 104 is actually a personal computer, a laptop, or any other computing device that does not have native NFC or RFID communication possible, the computing device may be equipped with an NFC or RFID reader and the communications can be passed from contactless card 102 to first computing device 104 or second computing device 110 via the NFC/RFID reader.

In some embodiments, contactless card 102 can be a card issued by the entity of an account associated with the card, such as an automobile insurance card issued by an automobile insurance provider for an automobile insurance policy, a medical insurance card issued by an medical insurance provider for an medical insurance policy, or the like. In these embodiments, contactless card 102 may include a unique customer identifier that is associated with the corresponding account. In some embodiments, contactless card 102 can be a card that is not issued by the entity of a pertinent account, but may be associated with the pertinent account. For example, contactless card 102 can be a card issued by a banking entity, a school identity card issued by an educational entity, or a driver's license issued by the Department of Motor Vehicles, where the card includes a unique customer identifier that is not directly associated with a pertinent account, but the customer identifier may be stored in a database with one or more other identifiers associated with a pertinent account. For example, an automobile insurance provider may store in a database, such as a backend server, the customer identifier of a driver's license with an associated identifier of an automobile insurance account that the driver of the driver's license has. In this manner, the backend server can receive a customer identifier from contactless card 102 and determine the associated identifier for a pertinent account, to identify the indirectly associated pertinent account. In another example, the contactless card 102 may be issued by a banking entity and provide both banking services, e.g., is configured to perform transaction via an applet (transaction applet) and identity services via a different applet (identity applet). In some embodiments, contactless card 102 can include multiple identity applets to encrypt distinct identifying information stored in contactless card 102.

System 100 includes first computing device 104 and may additionally include second computing device 110, which may each be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. First computing device 104 and second computing device 110 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. It is understood that first computing device 104 and second computing device 110 can be distinct types of computing devices. For example, first computing device 104 can be a workstation and second computing device 110 can be a mobile device.

First computing device 104, second computing device 110, intermediary server 108, and backend server 112 can each include a processor and a memory to perform the steps described herein, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. First computing device 104 and second computing device 110 may further include a display and input devices. The display may be any device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, first computing device 104 and second computing device 110 may each execute one or more applications, such as software applications, that enable, for example, network communications with one or more components of system 100 and transmit and/or receive data. System 100 may include one or more intermediary servers 108 and one or more backend servers 112. The intermediary server 108 can route communications between one or more backend servers 112 and the first computing device 104 and the second computing device 110. Each server described herein may include one or more processors, coupled to memory and configured to perform the steps according to the described subject matter. Intermediary server 108 may be configured as a central system, server or platform to control and call various data at different times to execute a plurality of workflow actions. Intermediary server 108 may be configured to connect to the one or more databases. First computing device 104, second computing device 110, intermediary server 108, and backend server 112 may be communicatively connected to each other via one or more networks 106. First computing device 104 and second computing device 110 may operate as a respective front-end to back-end pair with backend servers 112. First computing device 104 may transmit, for example from a mobile device application executing on first computing device 104, messages to intermediary server 108 and receive messages by the application from intermediary server 108. Second computing device 110 may similarly communicate with intermediary server 108.

System 100 may include one or more networks 106. In some examples, network 106 may be one or more of a wireless network, a wired network or any combination of wireless network and wired network, and may be configured to connect first computing device 104 and second computing device 110 to intermediary server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. Network 106 may further include one network, or any number of the exemplary types of networks mentioned above, operating as a stand-alone network or in cooperation with each other. Network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

There are many circumstances in which users may need to provide identifying information but may not want the identifying information disclosed to the recipient. Examples of such circumstances include exchanging automobile insurance information among drivers involved in an automobile collision, providing medical insurance information during check-in at a hospital or while purchasing prescription drugs at a pharmacy, or providing personal information for a social networking platform, such as a dating website. Contactless card 102 can be issued by or on behalf of an insurance entity, such as an automobile insurance entity or a health insurance provider, and the stored identifying information of the respective automobile insurance account or health insurance account can include identifiers of the insurance entity, policy number, and policy coverage such as an itemized list of deductible and copay amounts. In embodiments, contactless card 102 can be used in a social networking context, such as online dating networks, to verify during an in-person meeting a user's identity or details about the user, such as affiliation with the social network, employment status, name of employer, income, and area of residence. The information stored on contactless card 102 can be encrypted and sent to the recipient's device, where it can be forwarded to a server for verification without disclosing the information to the recipient. Specifically, contactless card 102 can store identifying information in memory, generate an encryption of the identifying information using an applet executing on the contactless card 102, and send the encrypted identifying information to the recipient's device, which is first computing device 104.

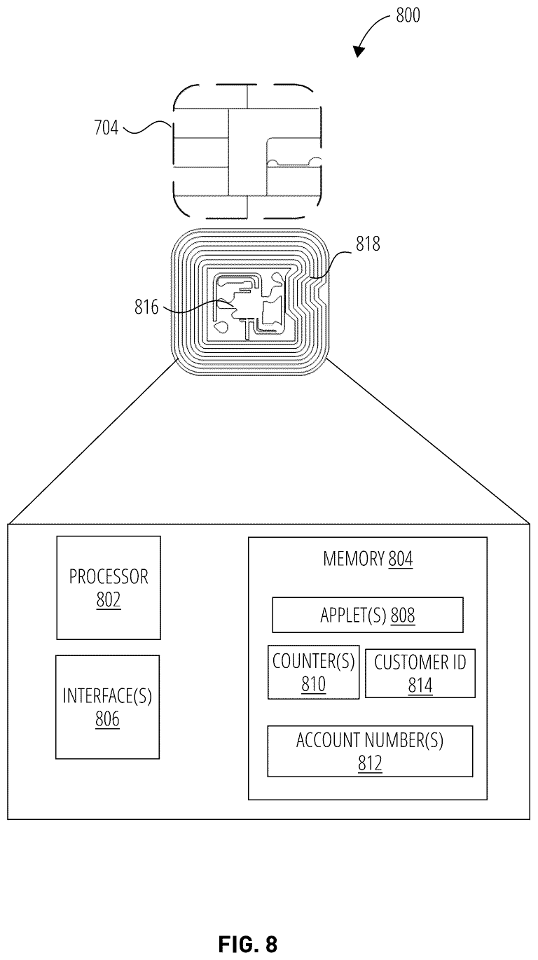

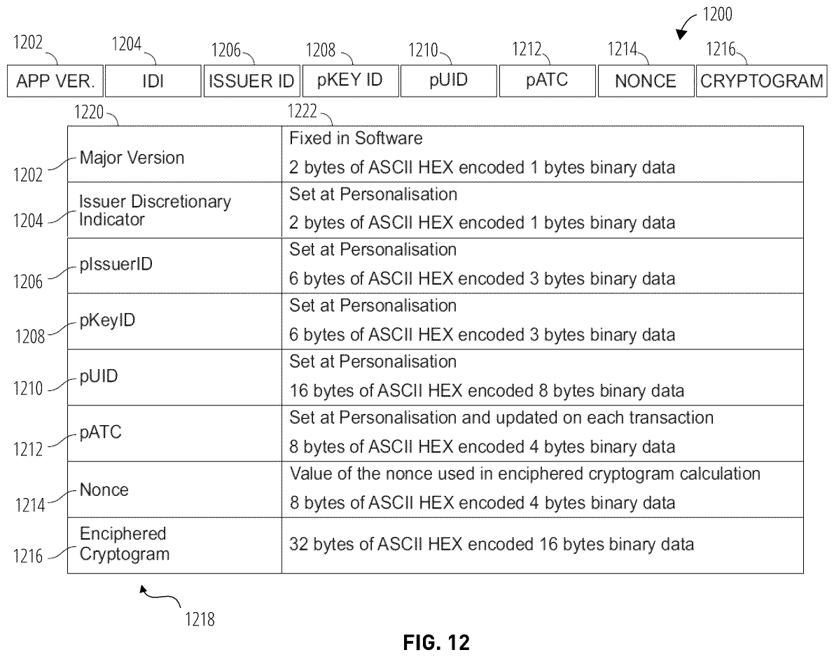

The identifying information can include identifying information of a user associated with contactless card 102 and/or identifying information of an account associated with the contactless card 102 and the user. Identifying information of the user can include the user's name, address, contact information, job title, salary, name of employer, physical characteristics such as height, weight, hair color, eye color, race, and one or more photographs of the user. The identifying information can include a customer identifier unique to each contactless card 102, such as customer identifier 814 shown in FIG. 8. The customer identifier may comprise a unique alphanumeric identifier assigned to a user of contactless card 102, and the customer identifier may distinguish the user of the contactless card from other contactless card users. In some examples, the customer identifier may identify both a customer (or user) and an account assigned to that customer and may further identify the contactless card 102 associated with the customer's account. In some embodiments, the identifying information can include Issuer Identifier 1206 shown in FIG. 12.

First computing device 104, second computing device 110, intermediary server 108, and backend server 112 can each include at least one processor and a memory to perform the steps described herein, a network connection, and be communicatively connected to each other via network 106 or any other suitable network such as a local area network (LAN), mobile communications network (e.g., 2G, 3G, 4G, LTE, 5G, 6G, etc.), wide area network (WAN), wireless LAN (WLAN), or any other suitable network. Contactless card 102 can send any information described herein to first computing device 104 and second computing device 110 via tapping utilizing NFC, Bluetooth, and/or Wi-Fi.

In the context of reporting an automobile collision, contactless card 102 can be associated with a user, referred to herein as a second user, and the second user's automobile insurance policy, which is referred to herein as a second account. The second user associated with contactless card 102 can cause contactless card 102 to communicate with first computing device 104, which can be a mobile device of the other driver, referred to herein as a first user, and associated with the first user's automobile insurance policy, which is referred to herein as a first account. For example, the second user can tap contactless card 102 to or position it near first computing device 104. Contactless card 102 can generate an encrypted payload including encrypted identifying information and transmit the encrypted payload to an application executing on first computing device 104.

First computing device 104, while not having the capability of deciphering the encrypted payload, forwards the encrypted payload to intermediary server 108. The application on first computing device 104 can also forward identifying information of the first driver, that is the driver associated with the first computing device 104, which intermediary server 108 can use to direct the encrypted payload and the identifying information of the other driver to the appropriate backend server 112. It is understood that, without deviating from the described subject matter, a website can be used instead of the application or the application can launch a website. The application can require a login and/or credentials for the other driver to access a user account in the application. The application or website can be hosted on backend server 112 or another server.

Backend server 112 can be a server associated with the automobile insurance entity of the first driver's first account, wherein the application executing on first computing device 104 is associated with the first account. In some embodiments, system 100 can exclude intermediary server 108 and the application on first computing device 104 can communicate directly with backend server 112. The same server or another server can also submit a claim of automobile collision using the identifying information of the first and second accounts.

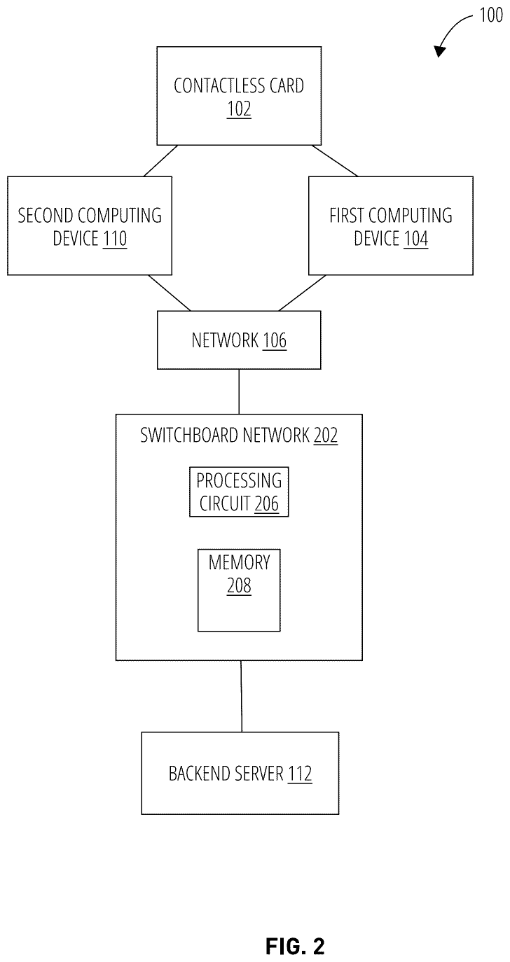

FIG. 2 illustrates a connection system 200 with a switchboard network 202. Similar to system 100 shown in FIG. 1, system 200 may include a contactless card 102, first computing device 104, second computing device 110, network 106, and backend server 112. Unlike system 100, system 200 utilizes a switchboard network 202 instead of intermediary server 108 to route communications between first computing device 104 and backend server 112 and between second computing device 110 and backend server 112.

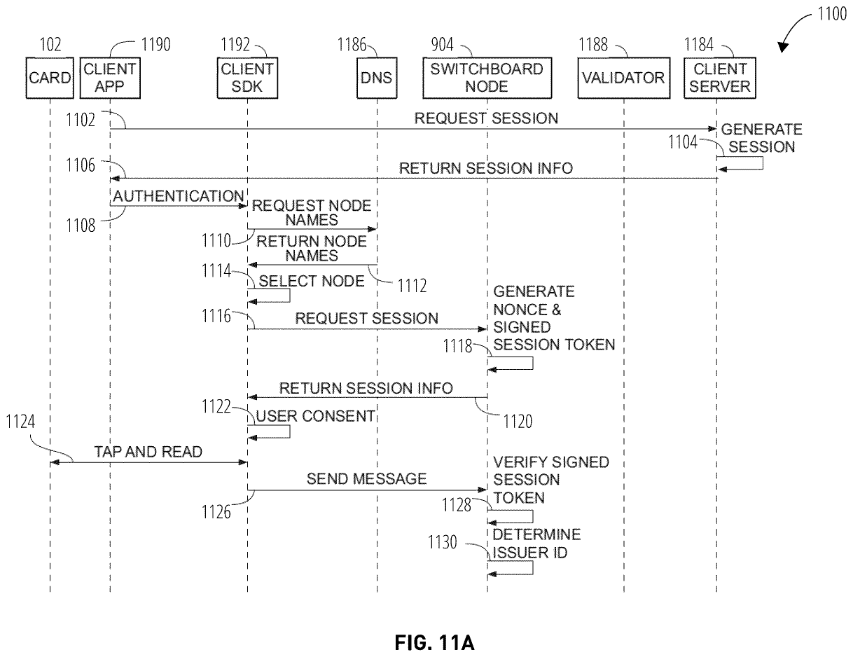

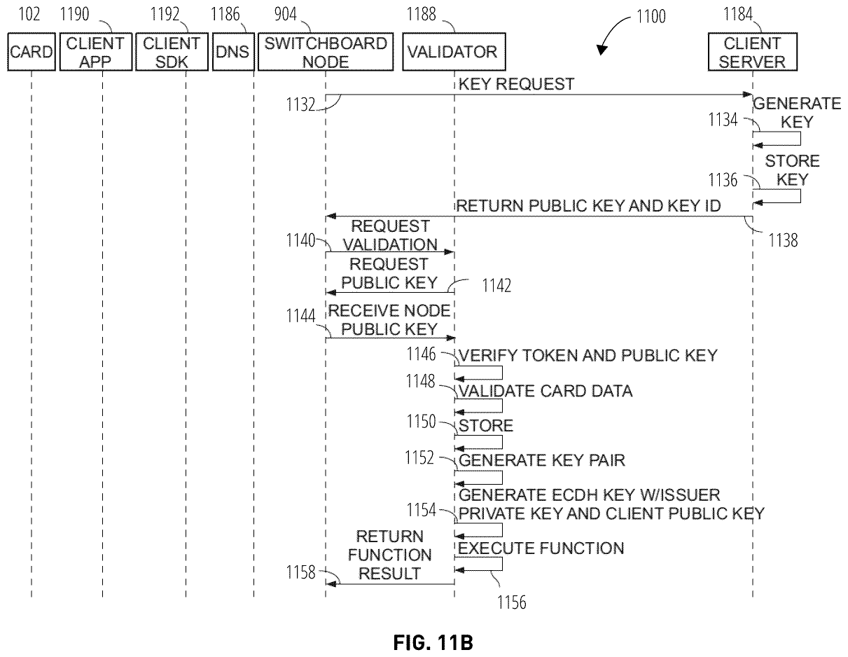

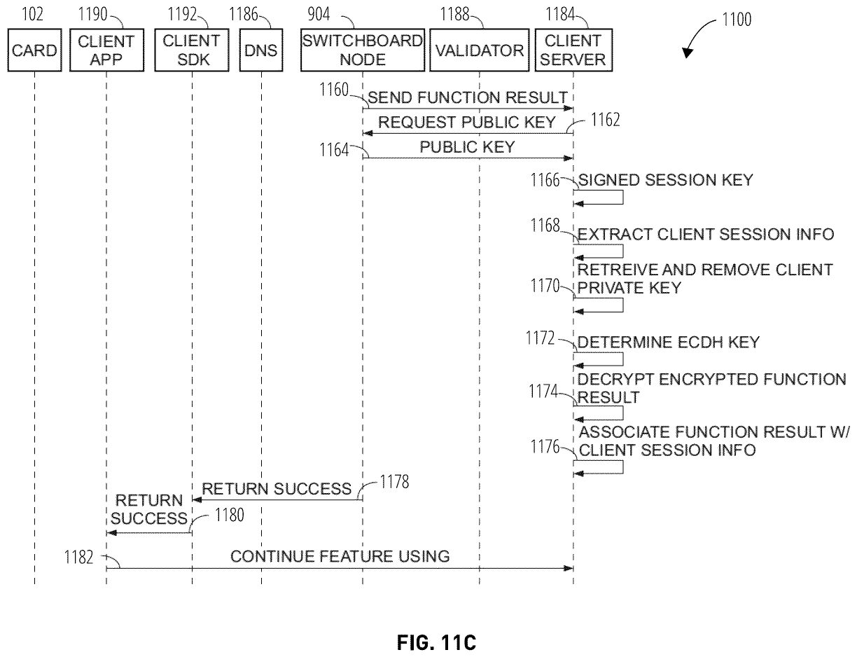

As discussed in further detail herein, the switchboard network 202, which includes at least one processing circuit 206 coupled to memory 208 to perform the steps described herein, communicates with first computing device 104, second computing device 110, and contactless card 102 via first computing device 104 or second computing device 110 to initiate authentication, with the backend server 112, of the account associated with contactless card 102, namely the second account. Once backend server 112 verifies or authenticates the user account, switchboard network 202 sends a message to first computing device 104 indicating that the second account has been validated or authenticated. In some embodiments, one or more servers other than backend server 112 may conduct the authentication of the second account, for example validator 1188 in FIG. 11A-FIG. 11C.

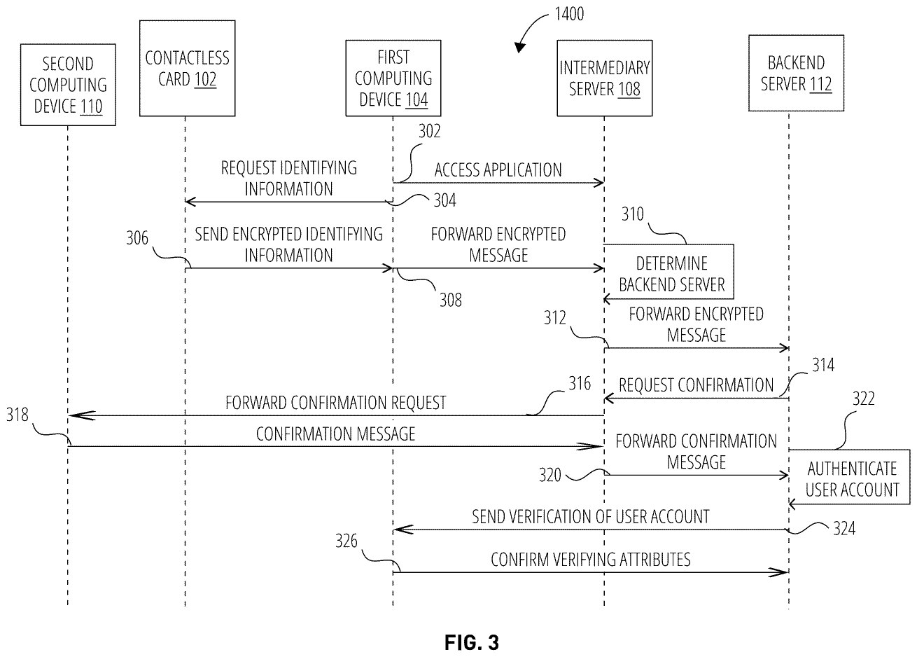

FIG. 3 shows a sequence flow illustrating an example process 300 for transmitting a hidden identity. At step 302, a first user associated with a first account accesses an application executing on first computing device 104. The application may require login credentials to initially verify the identity of the first user and to confirm the first account. The application may access stored identifying information of the first user and the first account. The first user associated with the first account can indicate in the application an event that requires identifying information of the first user associated with the application or another user. In some embodiments, the event is an automobile collision and the account is the user's automobile insurance account. The application can retrieve stored identifying information of the first user and the first account, such as the user's name, contact information, automobile insurance entity, and automobile insurance policy number.

At step 304, the application on first computing device 104 communicates with the contactless card 102 (e.g., after being brought near the contactless card 102). Communication between the application and the contactless card 102 may involve the contactless card 102 being sufficiently close to a card reader (not shown) of the first computing device 104 to enable NFC data transfer between the application and the contactless card 102. The application on first computing device 104 can send contactless card 102 a request for identifying information associated with contactless card 102. In some examples, the request can include an instruction to generate a MAC cryptogram. Communications between the application and contactless card 102 can include a read, such as an NFC read, of a near field data exchange (NDEF) tag, which may be created in accordance with the NFC Data Exchange Format. For example, a reader application, such as the application executing on first computing device 104, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by contactless card 102 may be updated or incremented, which may be followed by “Read NDEF file.”

At step 306, contactless card 102 encrypts identifying information associated with a second account and contactless card 102 and sends the encrypted payload to the application on first computing device 104. In the context of reporting an automobile accident, the identifying information can include the name and contact information of the second user associated with contactless card 102 and the name of the automobile insurance entity and the policy number for the second user's automobile insurance coverage. The identifying information can include an identifier unique to contactless card 102, such as customer identifier 814 shown in FIG. 8. The identifying information may also include Issuer Identifier 1206 shown in FIG. 12. In some embodiments, portions of the encrypted payload may remain not encrypted, such as a customer identifier, Issuer Identifier 1206, and/or a session key used to generate the encryption.

After communication has been established between first computing device 104 and contactless card 102, contactless card 102 generates the encrypted payload or data, which may include a message authentication code (MAC) cryptogram. In some examples, this may occur when the contactless card 102 is read by the application. The message may then be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key, which can be generated from a master key that backend server 112 or another server configured for performing authentication has. Thereafter, the cryptogram and the header may be concatenated, and encoded as ASCII hex and returned in NDEF message format (responsive to the “Read NDEF file” message). In some examples, the MAC cryptogram may be transmitted as an NDEF tag, and in other examples the MAC cryptogram may be included with a uniform resource indicator (e.g., as a formatted string). Contactless card 102 sends the MAC cryptogram to the application. In some examples, the transmission of the MAC cryptogram occurs via NFC, however, the present disclosure is not limited thereto. In other examples, this communication may occur via Bluetooth, Wi-Fi, or other means of wireless data communication. The application communicates the MAC cryptogram to the processor on first computing device 104.

At step 308, first computing device 104 forwards the encrypted payload to intermediary server 108.

At step 310, intermediary server 108 determines which backend server is associated with the second account, namely backend server 112. In some embodiments, intermediary server 108 uses a unique customer identifier, such as customer identifier 814, in the received message to determine the backend server associated with the second account. In some embodiments, the customer identifier can indicate the associated backend server. In other embodiments, intermediary server 108 may utilize a database with stored customer identifiers and identifiers of the associated backend servers to determine the backend server associated with the second account. In some embodiments, customer identifiers may not be directly associated with an account, but the customer identifiers of contactless cards may be associated with identifiers of accounts according to the corresponding user, which may be stored in a database. Intermediary server 108 may use the database that stores customer identifiers of contactless cards with associated identifiers of accounts to determine the identifier of the second account that is associated with the user of contactless card 102 and determine the backend server based on the identifier of the second account. In embodiments where Issuer Identifier 1206 is included in the encrypted payload, intermediary server 108 may utilize Issuer Identifier 1206 to identify the backend server associated with second account.

At step 312, intermediary server 108 forwards the encrypted payload to backend server 112.

Backend server 112 may optionally require confirmation that the holder of contactless card 102 provided the identifying information from contactless card 102. At step 314 and step 316, backend server 112 sends via intermediary server 108 a request for confirmation to the computing device of the user associated with contactless card 102, which is second computing device 110. Backend server 112 can require a confirmation message from second computing device 110 associated with contactless card 102 and the second account before initiating authentication of the second account. Second computing device 110 can prompt a user, who is understood to be associated with the second account, for confirmation that the user recently submitted identifying information of the second account. The prompt can further detail that the identifying information was recently submitted in association with an event as described herein, such as an automobile collision, a check-in for medical treatment, or purchase of prescription drugs.

The user can indicate confirmation on second computing device 110, such as by selecting a yes button, or indicate a refusal of confirmation on second computing device 110, such as by selecting a no button, if the user did not recently provide identifying information of the second account. In some embodiments, the confirmation prompt can include an additional level of security and request a user to enter credentials, such as a username, password, or biometrics, or to tap contactless card 102 to second computing device 110. At step 318, second computing device 110 sends the confirmation message to intermediary server 108 and, at step 320, intermediary server 108 forwards the confirmation message to backend server 112. In some embodiments, intermediary server 108 can generate and send the confirmation request to second computing device 110, and second computing device 110 can respond with a confirmation message directly to intermediary server 108. If intermediary server 108 or backend server 112 receive the confirmation message that indicates the user refused confirmation or the intermediary server 108 or backend server 112 did not receive a confirmation message within a predetermined threshold time since the confirmation request was sent, then backend server 112 will not proceed with authenticating the second account. In embodiments, intermediary server 108 may send the confirmation request before determining backend server 112 and before forwarding the encrypted message to backend server 112, thereby avoiding unnecessary communications if the user of the second account does not provide confirmation.

Backend server 112 or intermediary server 108 may use geolocation information of first computing device 104 and second computing device 110 to ensure that first computing device 104 and second computing device 110 are proximate to each other, for example within 10 feet, 15 feet, or 20 feet of each other. Instead of or in addition to requiring confirmation from second computing device 110, backend server 112 may require that first computing device 104 and second computing device 110 are proximate to each other before authenticating the user account associated with second computing device 110 and contactless card 102 and/or before storing a record of the event.

At step 322, backend server 112 authenticates the second account. Backend server 112 can have stored a key for decrypting the encrypted payload, such as a master key matching a master key used by contactless card 102 to generate the encrypted payload. If contactless card 102 generated a session key for the encryption, then backend server 112 can likewise generate a corresponding session key. Backend server 112 can authenticate the second account by matching the encrypted payload generated by the contactless card 102 and the encrypted payload generated by backend server 112. In some embodiments, a server other than backend server 112 has the master key, in which case the other server can perform the authentication and provide the results to backend server 112 or intermediary server 108. In some embodiments, backend server 112 can access a local or remote database that has stored the identifying information of the second account, retrieve the stored identifying information of the second account, and verify that the received identifying information matches the stored identifying information. In some embodiments, the encrypted payload can include an unencrypted session key or a component used for generating a session key, such as a counter, that is not encrypted, which backend server 112 uses to authenticate the second account.

At step 324, backend server 112 sends via intermediary servers 108 to first computing device 104 verification that the identifying information from contactless card 102 is authentic. In some embodiments, backend server 112 can also send to first computing device 104 verifying attributes associated with the second account, such as at least one of a photograph of a driver associated with the second account, a name of the driver associated with the second account, a license plate number of a vehicle associated with the second account, and a make and model, color, and year of the vehicle associated with the second account. The user associated with the first account can then visually verify whether the received verifying attributes match the attributes of the holder of contactless card 102 by comparing the received verifying attributes to the appearance of the driver, the driver's automobile, etc. Backend server 112 can retrieve the verifying attributes from the identifying information of the second account that was received in the encrypted message or the identifying information retrieved from the database.

In embodiments where backend server 112 sends verifying attributes to first computing device 104, at optional step 326, backend server 112 may receive confirmation from first computing device 104 that the verifying attributes match the driver or automobile, which backend server 112 may require before authenticating the second account and/or before storing a record of the event. After authentication, the application can forward the identifying information of the first and second accounts and any event information to a server associated with the first account to submit and file a claim.

Using an application on second computing device 110 similar to the application on first computing device, the second user associated with second computing device 110 and contactless card 102 can confirm authentication of identifying information of the first user associated with first computing device 104 received from a contactless card associated with the first account and the first user and submit a record of an event according to the same process described herein for authenticating the identifying information of the second user.

FIG. 3 illustrates communications between first computing device 104 and backend server 112 and between second computing device 110 and backend server 112 being routed by intermediary server 108. As described in FIG. 2, it is understood that intermediary server 108 can be replaced with switchboard network 202. It is also understood that in some embodiments, the described process may not include an intermediary server 108, and the application executing on first computing device 104 can store or retrieve the identity of backend server 112, allowing the first computing device 104 and backend server 112 to communicate directly. For example, identifying information may include an identifier of the backend server associated with the second account, which the application can use to send the encrypted payload to backend server 112. In the context of an automobile collision, backend server 112 can be a server associated with the first automobile insurance account and/or the second automobile insurance account, which the application on first computing device 104 identifies by the identifying information of the first account and second account, respectively.

Specifically, in some embodiments, the application can send the identifying information of the second account to a server associated with the entity of the first account, such as the automobile insurance provider of the first account. The server may then direct the identifying information of the second account to a server associated with the entity of the second account, such as the automobile insurance provider of the second account, to authenticate the second account. In other embodiments, the server may direct the identifying information to another server configured to determine the server associated with the entity of the second account. In some embodiments, the entities associated with the accounts have stored session keys and/or master keys for decrypting the encrypted payloads associated with the corresponding accounts.

In some embodiments, instead of receiving the identifying information from contactless card 102, the application may manually receive as input from the first user some identifying information of the second user, such as the second user's insurance policy number and the name of the insurance provider, which intermediary server 108 and/or backend server 112 can use to determine the server associated with the second account, and authenticate the second account.

In some embodiments, backend server 112, such as the server associated with the first account, can receive contact information or identifying information of the insurance provider and/or server associated with the second account. Backend server 112 can use the received information to authenticate the second account with the associated insurance provider.

In embodiments without intermediary server 108 that also implement the optional steps of requiring confirmation from second computing device 110 prior to authenticating the first user account, the encrypted payload from contactless card 102 may include the identity of second computing device 110, which backend server 112 can use to send the confirmation request directly to the second computing device 110. The confirmation request can include the identity of backend server 112, which second computing device 110 can use to respond directly to backend server 112.

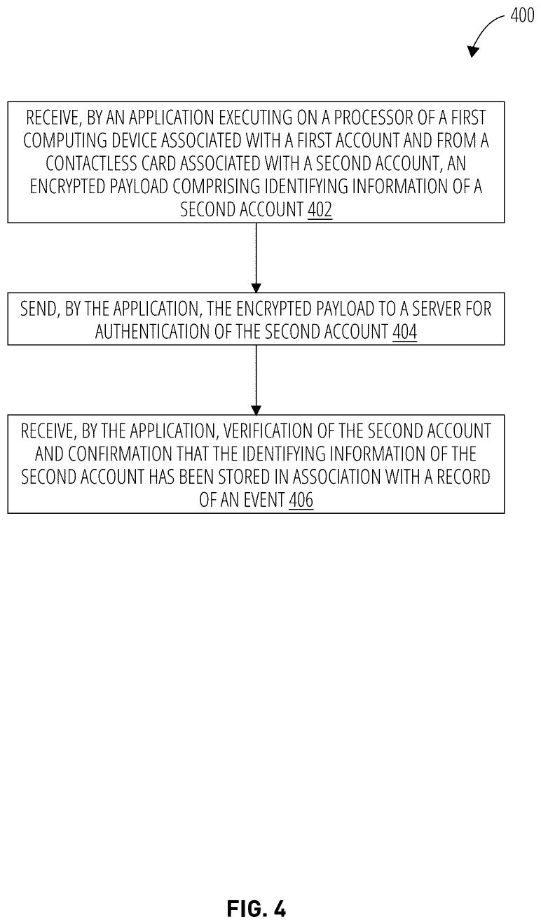

FIG. 4 is a flow chart of an example method 400 for transmitting a hidden identity by an application on a first computing device. In block 402, an application executing on a processor of a first computing device associated with a first account receives, from a contactless card associated with a second account, an encrypted payload comprising identifying information of a second account.

In block 404, the application sends the encrypted payload to a server for authentication of the second account. The server can require a confirmation message from a second computing device associated with the second account before initiating authentication of the second account. The second computing device can prompt a user, who is understood to be associated with the second account, for confirmation that the user recently submitted identifying information of the second account. The prompt can further detail that the identifying information was recently submitted in association with an event as described herein, such as an automobile collision, a check-in for medical treatment, or purchase of prescription drugs. The prompt can request a user to enter credentials, such as a username, password, or biometrics, or to tap the contactless card to the second computing device. The second computing device can generate the confirmation message in response to receiving confirmation from the user, such as tapping the contactless card to the second computing device. The application can also send identifying information of the first account to the server. For a user associated with the first account to verify that the contactless card and or the information on the card is indeed associated with the person holding the contactless card, the application can receive from the server verifying attributes associated with the second account including at least one of a photograph of a driver associated with the second account, a name of the driver associated with the second account, a license plate number of a vehicle associated with the second account, and a make and model of the vehicle associated with the second account. The user associated with the first account can then visually verify whether the received verifying attributes are indeed attributes of the holder of the contactless card.

In block 406, the application receives verification of the second account and confirmation that the identifying information of the second account has been stored in association with a record of an event. The confirmation can include confirmation that the identifying information of the first account and/or second account is stored in association with the record of the event. The event can include any of the types of events described herein. For example, the first and second accounts can be first and second automobile insurance accounts, respectively, and the event can be an automobile collision. Storing a record of the automobile collision can include reporting the automobile collision to at least an automobile insurance entity associated with the first automobile insurance account and can further include reporting the automobile collision to an automobile insurance entity associated with the second automobile insurance account. Accordingly, the record of the automobile collision can be stored in one or more servers associated with the automobile insurance entity of the first account and/or the automobile insurance entity of the second account. The application can receive confirmation that the record of the automobile collision has been filed with an automobile insurance entity associated with the first account based on the identifying information of the first account and the identifying information of the second account. The application and the server can communicate with each other via an intermediary server.

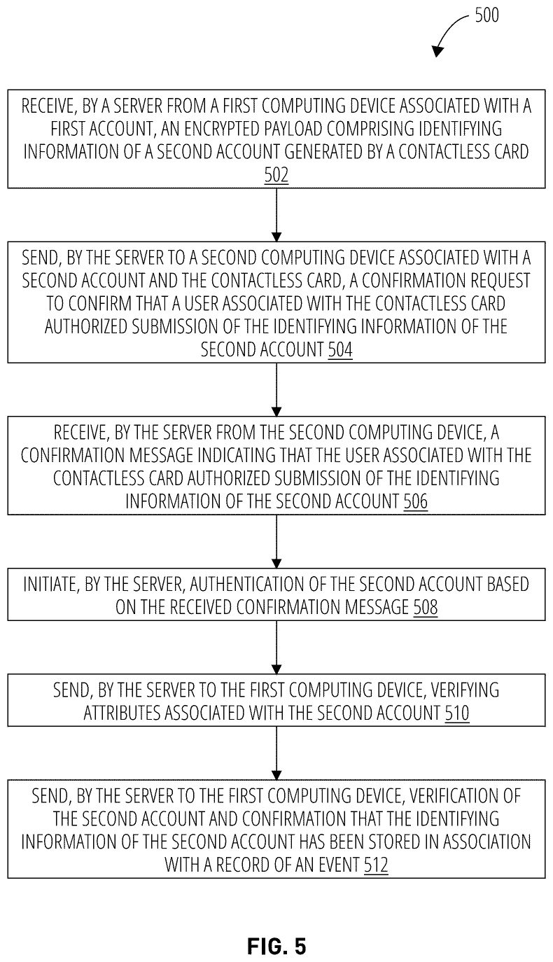

FIG. 5 is a flow chart of an example method 500 for transmitting a hidden identity by a server. In block 502, a server receives from a first computing device associated with a first account, an encrypted payload comprising identifying information of a second account generated by a contactless card. The server can also receive identifying information of the first account from the first computing device.

In block 504, the server sends to a second computing device associated with a second account and the contactless card, a confirmation request to confirm that a user associated with the contactless card authorized submission of the identifying information of the second account. The second computing device can prompt the user associated with the second account for confirmation that the user recently submitted identifying information of the second account. The prompt can further detail that the identifying information was recently submitted in association with an event as described herein, such as an automobile collision, a check-in for medical treatment, or purchase of prescription drugs. The prompt can request the user to enter credentials, such as a username, password, or biometrics, or to tap the contactless card to the second computing device.

In block 506, the server receives, from the second computing device, a confirmation message indicating that the user associated with the contactless card authorized submission of the identifying information of the second account. The second computing device can generate the confirmation message in response to receiving confirmation from the user, such as tapping the contactless card to the second computing device.

In block 508, the server initiates authentication of the second account based on the received confirmation message.

In block 510, the server sends, to the first computing device, verifying attributes associated with the second account. For a user associated with the first account to verify that the contactless card and or the information on the card is indeed associated with the person holding the contactless card, the application can receive from the server verifying attributes associated with the second account including at least one of a photograph of a driver associated with the second account, a name of the driver associated with the second account, a license plate number of a vehicle associated with the second account, and a make and model of the vehicle associated with the second account. The user associated with the first account can then visually verify whether the received verifying attributes are indeed attributes of the holder of the contactless card. Server can send the verifying attributes before commencing the authentication of the second account and begin the authentication after receiving confirmation from the first computing device that the verifying attributes match the attributes of the other user's physical appearance, automobile, etc.

In block 512, the server sends, to the first computing device, verification of the second account and confirmation that the identifying information of the second account has been stored in association with a record of an event. The server can submit a record of the event with the identifying information of the first and second accounts to an entity associated with the first account and/or an entity associated with the second account. For example, in the context of reporting an automobile collision, the server can report the collision with the identifying information of the first and second automobile insurance accounts to the automobile insurance provider of the first account and the automobile insurance provider of the second account. The server can be a server associated with the entity associated with the first account. The server can be an intermediary server that routes communications between a backend server associated with the entity associated with the first account and the first and second computing devices. It is understood that the communications received from the server by the first computing device can be from an application execution on the first computing device.

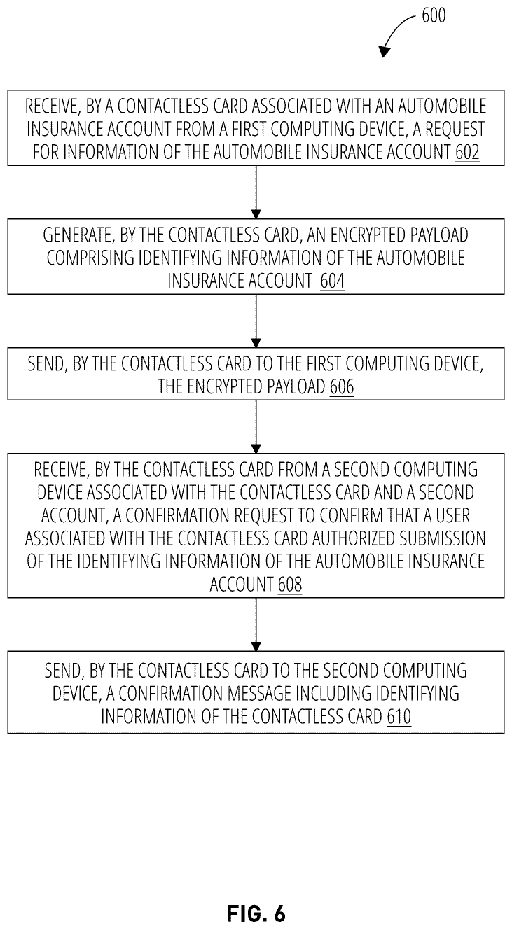

FIG. 6 is a flow chart of an example method 600 for transmitting a hidden identity by a contactless card. In block 602, a contactless card associated with an automobile insurance account receives a request for information of the automobile insurance account from a first computing device. The contactless card can include at least one identifier. The identifier can be issued by an automobile insurance entity associated with the automobile insurance account. The first computing device can be associated with a first automobile insurance account and the automobile insurance account associated with the contactless card can be a second automobile insurance account.

In block 604, the contactless card generates an encrypted payload comprising identifying information of the automobile insurance account. The encrypted payload can include a message authentication code (MAC). One or more portions of the encrypted payload may be unencrypted, such as a customer identifier, Issuer Identifier, and/or a session key used for the encryption.

In block 606, the contactless card sends the encrypted payload to the first computing device.

In block 608, the contactless card receives, from a second computing device associated with the contactless card and a second account, a confirmation request to confirm that a user associated with the contactless card authorized submission of the identifying information of the automobile insurance account.

In block 610, the contactless card sends a confirmation message including identifying information of the contactless card to the second computing device.

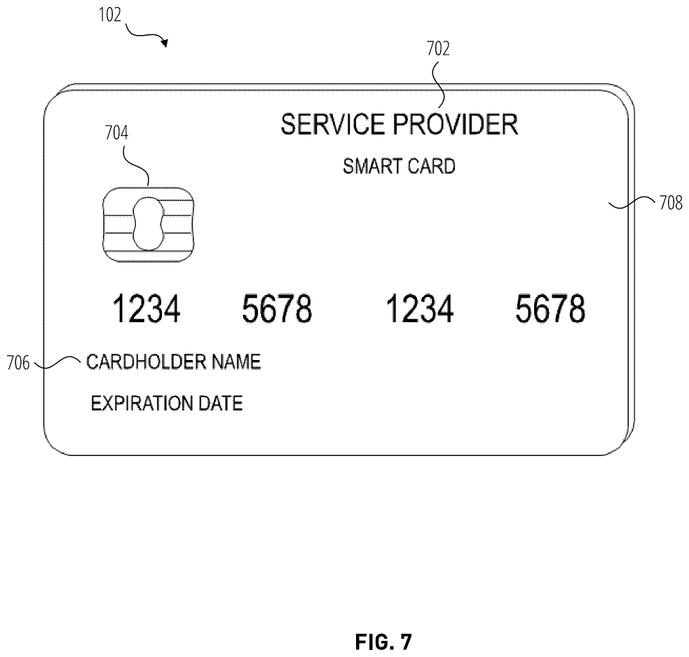

FIG. 7 illustrates an example configuration of a contactless card 102, which may include a contactless card, a payment card, such as a credit card, debit card, or gift card, issued by a service provider as displayed as service provider indicia 702 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 708, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

The contactless card 102 may also include identification information 706 displayed on the front and/or back of the card, and a contact pad 704. The contact pad 704 may include one or more pads and be configured to establish contact with another computing device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 8. These components may be located behind the contact pad 704 or elsewhere on the substrate 708, e.g. within a different layer of the substrate 708, and may electrically and physically coupled with the contact pad 704. The contactless card 102 may also include a magnetic strip or tape, which may be located on the back of the card (not shown in FIG. 7). The contactless card 102 may also include a Near-Field Communication (NFC) device coupled with an antenna capable of communicating via the NFC protocol. Embodiments are not limited in this manner.

As illustrated in FIG. 7, the contact pad 704 of contactless card 102 may include processing circuitry 816 for storing, processing, and communicating information, including a processor 802, a memory 804, and one or more interface(s) 806. It is understood that the processing circuitry 816 may contain additional components, including processors, memories, error and parity/CRC checkers, data encoders, anticollision algorithms, controllers, command decoders, security primitives and tamperproofing hardware, as necessary to perform the functions described herein.

The memory 804 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 804 may be encrypted memory utilizing an encryption algorithm executed by the processor 802 to encrypted data.

The memory 804 may be configured to store one or more applet(s) 808, one or more counter(s) 810, a customer identifier 814, and the account number(s) 812, which may be virtual account numbers. The one or more applet(s) 808 may comprise one or more software applications configured to execute on one or more contactless cards, such as a Java® Card applet. However, it is understood that applet(s) 808 are not limited to Java Card applets, and instead may be any software application operable on contactless cards or other devices having limited memory. The one or more counter(s) 810 may comprise a numeric counter sufficient to store an integer. The customer identifier 814 may comprise a unique alphanumeric identifier assigned to a user of the contactless card 102, and the identifier may distinguish the user of the contactless card from other contactless card users. In some examples, the customer identifier 814 may identify both a customer and an account assigned to that customer and may further identify the contactless card 102 associated with the customer's account. As stated, the account number(s) 812 may include thousands of one-time use virtual account numbers associated with the contactless card 102. An applet(s) 808 of the contactless card 102 may be configured to manage the account number(s) 812 (e.g., to select an account number(s) 812, mark the selected account number(s) 812 as used, and transmit the account number(s) 812 to a mobile device or a first computing device 104 for autofilling by an autofilling service.

In some embodiments, the memory 804 can include (e.g., have stored therein) the data from the fields shown in FIG. 8 and/or FIG. 12. The processor 802 can then use the data from the fields to generate the message 1200 as described above.

The processor 802 and memory elements of the foregoing exemplary embodiments are described with reference to the contact pad 704, but the present disclosure is not limited thereto. It is understood that these elements may be implemented outside of the contact pad 704 or entirely separate from it, or as further elements in addition to processor 802 and memory 804 elements located within the contact pad 704.

In some examples, the contactless card 102 may comprise one or more antenna(s) 818. The one or more antenna(s) 818 may be placed within the contactless card 102 and around the processing circuitry 816 of the contact pad 704. For example, the one or more antenna(s) 818 may be integral with the processing circuitry 816 and the one or more antenna(s) 818 may be used with an external booster coil. As another example, the one or more antenna(s) 818 may be external to the contact pad 704 and the processing circuitry 816.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 818, processor 802, and/or the memory 804, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 808 may be added to contactless cards to provide a one-time password (OTP) for multifactor authentication (MFA) in various mobile application-based use cases. Applet(s) 808 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 808 may be configured to encode the OTP as an NDEF type 4 well known type text tag. In some examples, NDEF messages may comprise one or more records. The applet(s) 808 may be configured to add one or more static tag records in addition to the OTP record.

In some examples, the one or more applet(s) 808 may be configured to emulate an RFID tag. The RFID tag may include one or more polymorphic tags. In some examples, each time the tag is read, different cryptographic data is presented that may indicate the authenticity of the contactless card. Based on the one or more applet(s) 808, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 810 may be configured to increment. In some examples, each time data from the contactless card 102 is read (e.g., by a mobile device), the counter(s) 810 is transmitted to the server for validation and determines whether the counter(s) 810 are equal (as part of the validation) to a counter of the server.

The one or more counter(s) 810 may be configured to prevent a replay attack. For example, if a cryptogram has been obtained and replayed, that cryptogram is immediately rejected if the counter(s) 810 has been read or used or otherwise passed over. If the counter(s) 810 has not been used, it may be replayed. In some examples, the counter that is incremented on the card is different from the counter that is incremented for transactions. The contactless card 102 is unable to determine the application transaction counter(s) 810 since there is no communication between applet(s) 808 on the contactless card 102.

In some examples, the counter(s) 810 may get out of sync. In some examples, to account for accidental reads that initiate transactions, such as reading at an angle, the counter(s) 810 may increment but the application does not process the counter(s) 810. In some examples, when the first computing device 104 is woken up, NFC may be enabled and the first computing device 104 may be configured to read available tags, but no action is taken responsive to the reads.

To keep the counter(s) 810 in sync, an application, such as a background application, may be executed that would be configured to detect when the mobile first computing device 104 wakes up and synchronize with the server of a banking system indicating that a read that occurred due to detection to then move the counter(s) 810 forward. In other examples, Hashed One Time Password may be utilized such that a window of mis-synchronization may be accepted. For example, if within a threshold of 10, the counter(s) 810 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 810 increases in the appropriate sequence, then it possible to know that the user has done so.

The key diversification technique described herein with reference to the counter(s) 810, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

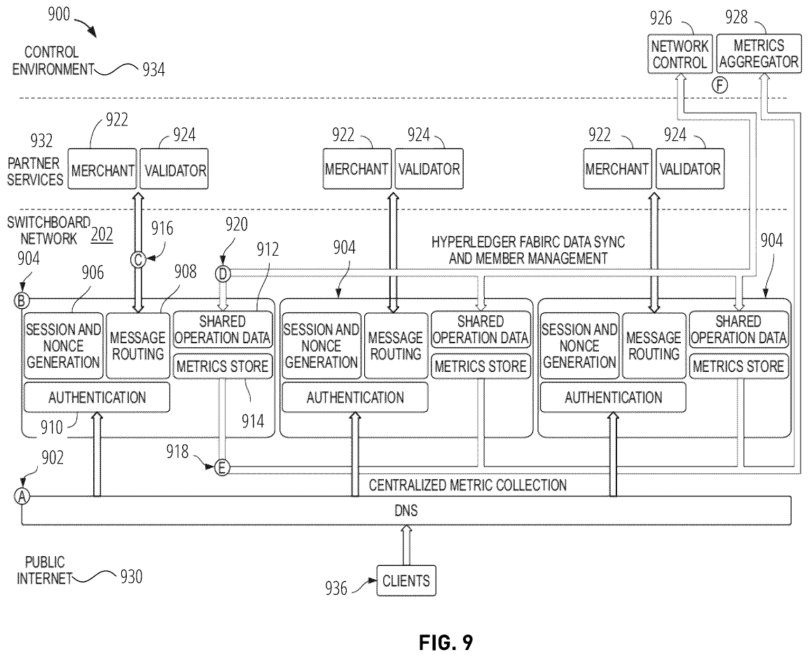

FIG. 9 illustrates an example of system 900 in accordance with the embodiments discussed herein. The system 900 includes additional devices and systems configured to enable contactless card issuers to tap-to-card services. Specifically, system 900 enables any number of issuer systems to provide card services to their clients through a switching fabric, i.e., the switchboard system in a secure and safe manner.

In embodiments, the switchboard system includes one or more nodes 904 configured to perform routing operations. Each switchboard node 904 may include a session and nonce generator 906, a message router 908, an authentication 910, an operation data 912 store, and a metrics store 914. Further, each of the nodes may be configured the same and share configurations, but each switchboard node 904 may independently process and route messages and requests to the appropriate systems, such as the merchant systems and issuer systems. Each of the nodes 904 is configured to act as a broker of trust between an issuer system, the merchant system 922, and/or validation system 924, for example. Each switchboard node 904 is configured to route each message to the correct issuer system while maintaining data security. For example, a switchboard node 904 may route a message between an issuer system and a merchant system while the node cannot access the private data in the message.

The switchboard system 900 may be configured as a server system with a collection of hardware, software, and networking components that work together to provide client services. Hardware components may include one or more server computers, storage devices, and network adapters. The server computers are configured to run server applications, such as those executable on each of the nodes 904. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

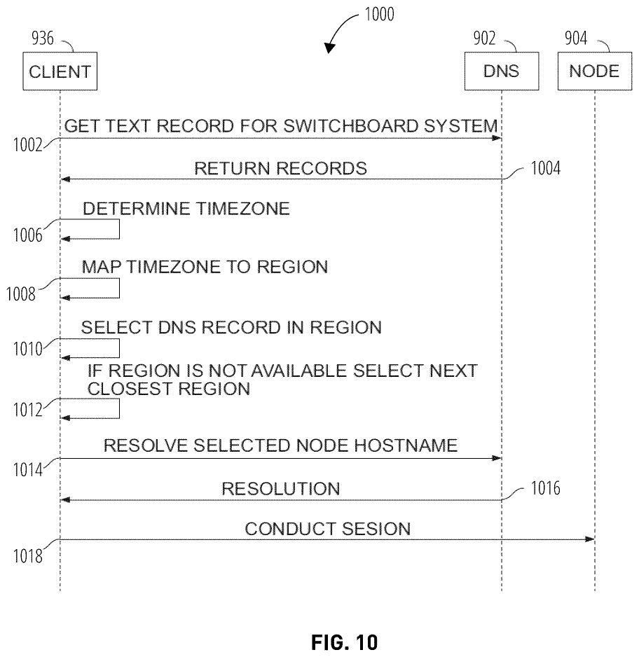

In some embodiments, the nodes 904 may operate in a cloud-based computing environment, e.g., a collection of hardware, software, and networking components that enable the delivery of cloud computing services. The switchboard nodes 904 and the computing services are delivered over the Internet and can be accessed from anywhere in the world with an Internet connection. In embodiments, client 936 may access a switchboard node 904 through DNS 902 or Domain Name System (DNS). The DNS 902 is a hierarchical and distributed naming system for computers, services, and other resources connected to the Internet or other networks. It associates various information with domain names assigned to each registered participant. In one example, the DNS 902 may translate a name known to software executing on a client 936 to route data to one or more of switchboard node 904 of the switchboard system. In embodiments, the DNS 902 may generate a number, such as an Internet Protocol (IP) address, an address record (A-record), or another Hostname (C-name record). FIG. 10 illustrates one example sequence 1000 for a client to identify and resolve an identifier for one of the nodes 904 of the switchboard system. At a high level, the DNS 902 translates known domain names to numerical Internet Protocol (IP) addresses needed for locating and identifying computer services and devices with the underlying network protocols. Clients use the global DNS system to select the best node to use, as discussed in sequence 1000.

In embodiments, a client 936 communicates with the switchboard system to perform one or more of the partner services 932, such as conducting a transaction with a merchant, validating the customer, or other tap-to functions. Once client 936 identifies a switchboard node 904 and resolves an address to communicate with switchboard node 904, client 936 may send one or more messages to switchboard node 904 to authenticate and perform the operation. The switchboard node 904 includes an authentication 910 function that is configured to authenticate the client 936. In embodiments, the client 936 sends a message or authorization request to the switchboard node 904 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 66535 | Client ID | Individual |
| | | identifier |
| | | of client |
| GReyx5BuEAaE72bWbFZJfHRL8Dbt1Uum | Client Key | Randomly |
| | | assigned key |

The switchboard node 904 may authorize or authenticate the client 936 or user, and the switchboard node 904 may utilize the additional components, such as the session and nonce session and node generator 906 and message router 908, to perform the operations. Note the validation systems validation system 924 never interact with the merchant systems 922, nor vice versa. The nodes node 904 brokers all communication.

In embodiments, the switchboard system may utilize a hyper ledger fabric 920 to manage to synchronize the shared operation data 912 and member management across the network. The hyperledger fabric 920 is distributed ledger framework having a permissioned network model that only authorized participants can join the network and access the data that is stored on a ledger.

In embodiments, the hyperledger fabric 920 may be generated by creating one or more sets of peers, an ordering service, and a channel. Once the network is created, system 900 deploys chaincode to the network, or node 904 is permitted to access the fabric. The chaincode is the code that runs on the blockchain and executes the network control 926 and operation data 912 logic code. Once the chaincode is deployed, each of the switchboard nodes 904 is configured to invoke transactions on the blockchain to add data to the blockchain, e.g., the operational data. A switchboard node 904 or another device can query the ledger to retrieve data. The ledger is a distributed database that stores all the data added to the blockchain.

All nodes 904 keep an independently verifiable log of their actions that can be transmitted to a centralized aggregator to build a picture of overall network usage. System 900 can manage network operation data and management at a central level and have a centralized view of network use, aggregated and abstracted to the appropriate level.

FIG. 10 illustrates an example sequence 1000 for a client to utilize DNS to resolve and communicate with one or more nodes of a switchboard system. The illustrated sequence 1000 includes a client 936, a DNS 902, and a switchboard node 904. At 1002, the sequence 1002 includes the client 936 sending a request to a default DNS server for a text record switchboard. {domain}. {tld}. The text record may be preconfigured in a client app and/or client SDK. At 1004, the DNS 902 returns one or more records. A DNS record structure may include the following:

```
• Root Record:
  ∘ Name: switchboard.{domain}.{tld}
  ∘ Type: TXT
  ∘ Resolution:
    ▪ {nodename_1}.{operator_a}.{region_i}.switchboard.{domain}.{tld},
    ▪ {nodename_2}.{operator_a}.{region_i}.switchboard.{domain}.{tld},
    ▪ {nodename_1}.{operator_b}.{region_ii}.switchboard.{domain}.{tld},
    ▪ {nodename_2}.{operator_b}.{region_ii}.switchboard.{domain}.{tld},
    ▪ * etc.
  ∘ Used For determining where there are active nodes
• Node Record:
  ∘ Name: {nodename}.{operator}.{region}.switchboard.{domain}.{tld}
  ∘ Type: A/AAAA or CNAME
  ∘ Resolution: Actual node hostname or IP
  ∘ Used For: communicating with a node 904
```

In embodiments, the client 936 may determine the current timezone at 1006. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1008, the client 936 is configured to map the timezone to a region or short-version identifier of the region. One example includes America/New_York->na-e. The region may be based on DNS names, for example. Table 2 illustrates a few examples of timezone mappings to regions:

TABLE 2

| | | Short |
|---|---|---|
| Timezone | Region | Version |
| America/New_York | North America/East | na-e |
| America/Buenos_Aires | South America | sa |
| US/Pacific | North America/West | na-W |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<−>na-w and sa<−>na-w and sa<−>na-e. This representation is useful for node selection.

At 1010, the client 936 may identify or select a DNS record option returned at 1004 that is in the region. If there are multiple matches, the client 936 may select one at random. If there's no node available in a region, the client 936 may determine and use a data graph of neighboring regions to select a node in the closest region where a node is available at 1012. For example, sa has no node but is connected to na-e where there is a node and so na-e is selected. In some embodiments,

At 1014, the client may resolve a selected node's hostname. In embodiments, the client 936 may automatically resolve the hostname using the client's HTTP request default resolver. At 1016, the DNS 902 may return a result. And at 1018, the client 936 may communicate with a switchboard node 904 and begin the process to interact with the switchboard.

FIG. 11A-FIG. 11C illustrate an example sequence 1100 to perform operations between a contactless card 102 and services provided by a card issuer and/or merchant. The illustrated sequence 1100 includes actions and communications performed by a contactless card 102, a client 936 including a client app 1190 and a client SDK 1192, a DNS 1186, a switchboard system including one or more nodes 904, a partner services 932 including a merchant and/or validator 1188, and control services 934 including a client server 1184 or system. In embodiments, the client app 1190 may be any application configured to execute on a client 936, such as a banking app, a merchant app, a social media app, a travel app, a gaming app, a productivity app, an entertainment app, and so forth. In embodiments, the client app 1190 includes a web browser to provide websites and pages. The client app 1190 may include and/or utilize the client SDK 1192, which may be a set of instructions that enable the client app 1190 to communicate with other components of the switchboard system.

In embodiments, as shown in FIG. 11A, at 1102 the client 936 including the client app may send a request and establish a session with a client server 1184 such that a result may be associated with the correct computing device or user. The request establishes a relationship between the computing device and client server. At 1104, the client server 1184 generates a session and CLIENT SESSION INFORMATION. At 1106, the client server 1184 returns the session information, e.g., the CLIENT SESSION INFORMATION. In embodiments, the CLIENT SESSION INFORMATION may be the Client implementation-specific user session identification information.

At 1108, the client 936 may initiate a contactless card authentication process with the client 936. For example, the client 936 may call a function and/or pass information to the client 936 to initiate authentication via a contactless card 102. At 1110-1114, the client 936 may utilize DNS to identify a node and establish communication with the node. Specifically, at 1110, the client 936 including the client SDK 1192 may send a request for switchboard hostnames, and at 1112 the DNS 1186 may return information including one or more hostnames. At 1114, the client 936 may determine a switchboard node to communicate. FIG. 10 illustrates an example of a more detailed sequence of the process to establish communication with a switchboard node 904.

At 1116, the client 936 may send a request for a session to the switchboard system 900. In embodiments, the request for a session may be for a function request in the format <FUNCTION REQUEST>. In embodiments, the FUNCTION REQUEST may be the data/function that the client 936 would like to request once a contactless card 102 has been validated. The function could be for any service discussed herein, e.g., authenticate the user, perform a transaction, request autofill data, etc. At 1118, switchboard system 900 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>,<CLIENT SESSION INFO>, and<FUNCTION REQUEST> signed with <NODE PRIVATE KEY>, where the NODE PRIVATE KEY is the switchboard system 900 private key. The switchboard system 900 may include a NODE PUBLIC/PRIVATE KEY, which is a keypair used to sign and validate JWTs.

At 1120, the switchboard system 900 may return session information to the client 936. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1122, the client SDK 1192 may determine and/or receive user consent to the terms of service. In one example, the client SDK 1192 captures and records the user consent to<FUNCTION TOS> on <CONSENT DATE>with<TOS VERSION>. The CONSENT DATE may be the timestamp for the user's consent to the TOS.

At 1124, the client 936 exchanges one or more messages with a contactless card. In one example, the exchange may be based on the contactless card being tapped to a computing device. In embodiments, the client SDK 1192 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded |
| | | 4 bytes binary data |
| 0F . . . 12 | Session Indicators | 4 bytes of ASCII HEX encoded |
| | | 2 bytes binary data |
| 13 . . . 16 | Control Indicators | 4 bytes of ASCII HEX encoded |
| | | 2 bytes binary data |
| 17 . . . 26 | Update Date | 16 bytes of ASCII HEX encoded |
| | creation Time | 8 bytes binary data - represents |
| | | 64 bit unix timestamp |
| 27 . . . 36 | Update MAC | MAC to protect control |
| | | indicators - 16 bytes of |
| | | ASCII HEX encoded |
| | | 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 12, message 1200.

At 1124, the contactless card may generate and provide a message to the client's device including the client SDK 1192. The data in the message may be utilized by the system discussed herein to perform the function requested. One example of the message is illustrated and discussed in FIG. 12, message 1200.

At 1126, the client including the client SDK 1192 may send a message and information to the switchboard system 900. The message may be the message received from the contactless card 102, e.g., message 1200. In addition, the client SDK 1192 may send the consent date, the TOS version, and the signed session token to the switchboard system 900. The switchboard system 900 may utilize the information to ensure the session is valid. At 1128, the switchboard system 900 verifies the signed session token is valid, e.g., is the previously provided signed session token and includes the nonce previously generated and is in the message.

In some embodiments, the switchboard system 900 is configured to determine which issuer system or client-server it should route the message to for processing. At 1130, the switchboard system 900 may determine the issuer ID by extracting it from the message received from the contactless card 102 via the client SDK 1192. As mentioned, the issuer ID identifies the issuer of the contactless card 102.

FIG. 11B continues the sequence 1100 from FIG. 11A. In embodiments, the switchboard system 900 is configured to generate and communicate secure communications with the issuer system, e.g., the client server 1184 and the validator 1188. At 1132, the switchboard system 900 sends a request for a key to the client server 1184. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1134, the client server 1184 generates a portion of the key. In some instances, the client server 1184 may generate half of the ECDH key for encryption/decryption of PII. Specifically, the client server 1184 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1136, the client-server 1184 stores the generated portion of the key in storage. Specifically, the client server 1184 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1184 may return the public key portion to the switchboard system 900 with the KEY ID at 1138. The switchboard system 900 may store the public key portion with the KEY ID for later use, e.g., generation of the ECDH key. At 1140, the switchboard system 900 may request a validation to be performed by the validator 1188. In one example, the switchboard system 900 may send a request validation as Request validation <MESSAGE>, <SIGNED SESSION TOKEN>, <CLIENT EC PUBLIC KEY>, <CONSENT DATE>, and the <TOS VERSION>. The validator 1188 may make an out-of-band request back to the switchboard system 900 for the public key to verify the session at 1142. At 1144, the switchboard system 900 may provide the node's public key, i.e., <NODE PUBLIC KEY>. Further at 1146, the validator 1188 may utilize the node's public key to verify the secure session token.

In embodiments, the validator 1188 may validate the message at 1148. In embodiments, the validator 1188 may perform a number of validations including ensuring the nonce in the message is correct along with additional information, such as the card's unique identifier (pUID), and the counter value (pATC).

At 1150, the validator 1188 may store information associated with the session. For example, validator 1188 may store the <CONSENT DATE>with the <TOS VERSION> and the <PUID>. The validator 1188 may also generate another portion of the key, e.g., the ECDH key. For example, the 1188 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1154, the validator 1188 may generate the complete ECDH key. For example, the validator 1188 generates the <ECDH KEY> from <ISSUER EC PRIVATE KEY> and <CLIENT EC PUBLIC KEY>. The ECDH KEY is the final key generated using ECDH key negotiation.

The validator 1188 may utilize the ECDH KEY to encrypt data for the function. For example, if the validator 1188 validates the message in some instances, the validator 1188 may execute a function request to create a function result and encrypt the result with the ECDH KEY at 1156. For example, the validator 1188 may Execute <FUNCTION REQUEST> to create <FUNCTION RESULT> and encrypt it with the <ECDH KEY>. The function result may be any result based on the requested function, e.g., verification of the card.

At 1158, the validator 1188 may return the function result to the switchboard system 900. In some instances, the function result is returned encrypted. For example, the validator 1188 may return the <ENCRYPTED FUNCTION RESULT> and the <ISSUER EC PUBLIC KEY>.

FIG. 11C continues the sequence 1100 from FIG. 11B. In embodiments, at 1160 the switchboard system 900 sends the function result to the client server 1184 to process the result. In one example, the switchboard system 900 may send the <ENCRYPTED FUNCTION RESULT>, <KEY ID>, <ISSUER EC PUBLIC KEY>, and <SIGNED SESSION TOKEN>. At 1162 and 1164, the client server 1184 may make a request for and receive the public key from the switchboard system 900. In some instances, the exchange may be performed via out-of-band communication channels. The public key for the node may be <NODE PUBLIC KEY>. The public key may be used to verify the sender of the function result, etc. At 1166, the client server 1184 may verify the signed session key with the node's public key <NODE PUBLIC KEY> to verify the sender of the information. At 1168, the client server 1184 may extract client information from the signed session token. For example, the client server 1184 may Extract <CLIENT SESSION INFO> from <SIGNED SESSION TOKEN>, i.e., extracting the client implementation-specific user session identification information.

Further, at 1170, the client server 1184 may retrieve the client's private key with the KEY ID. Specifically, the client server 1184 may get and remove the <CLIENT PRIVATE KEY> from cache using the <KEY ID>. At 1172, the client server 1184 may generate or compute the ECDH key. For example, the client server 1184 may compute the <ECDH KEY>with the <CLIENT PRIVATE KEY>+<ISSUER EC PUBLIC KEY>. The client server 1184 may decrypt the function result with the computed key at 1174. Specifically, the client server 1184 may decrypt the <ENCRYPTED FUNCTION RESULT>with the <ECDH KEY> to determine the <FUNCTION RESULT>. At 1176, the client server 1184 associates the function result with the session.

In embodiments, the switchboard system 908 may return whether the function result was successfully completed or not at 1178 to the client SDK 1192. Further at 1180, the client SDK 1192 may notify the client app 1190 of the result. At 1182, the client app 1190 may utilize the feature. For example, the 1182 may communicate with the client server 1184 to continue the feature using the <CLIENT SESSION INFO> to fetch the redacted <FUNCTION RESULT>.

FIG. 12 illustrates an example of a message 1200 that may be communicated by a contactless card to perform the functions described herein, such as those discussed in FIG. 11A through FIG. 11C. One or more of the fields in message 1200 may also be utilized to route the message 1200 through the switchboard system and perform authentication/validation techniques.

In embodiments, the message 1200 includes an applet version 1202 field, an issuer discretionary indicator 1204 field, an Issuer Identifier 1206 field, a pKey ID 1208 field, a pUID 1210 field, a pATC 1212 field, a nonce 1214 field, and an encrypted cryptogram 1216.

In embodiments, the fields may be in plain text or encrypted. For example, the applet version 1202 field may include an applet version in plain text. The applet version indicates which applet version is installed on a contactless card and may be used by the other systems to determine how to process the message 1200 when communicated. For example, different Applet versions require different validation logic, e.g., an older message may be routed through the issuer system to perform various operations for validation, while a newer message may be routed through the switchboard system to perform the various operations, including validation.

In embodiments, the message 1200 includes an issuer discretionary indicator 1204 field that may include issuer data and set at the time of personalization. In addition, the message 1200 includes an Issuer Identifier 1206 field that may include a unique ID assigned to the entity issuing the card, e.g., the issuer. For example, when joining the system, each issuer may be assigned a unique identifier during an onboarding operation. The issuer ID can be used by the switchboard system 908 to route a message and its contents to the appropriate services that are associated with that particular issuer.

In embodiments, the message 1200 includes a pKey ID 1208 field. In some instances, the pKey ID 1208 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1200 may include a pUID 1210 field, including a card unique identifier assigned to the contactless card at personalization time. The pUID 1210 field data may be a combination of alphanumeric characters used to identify each card and associated with a user uniquely.

In embodiments, the message 1200 includes a pATC 1212 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1200 is created, a new session key is derived and utilized to generate one or more portions of the message 1200. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1200 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc., may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES(ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES(ASKL) [B], where DES is an encryption algorithm. The contactless card 102 computes B=[B XOR T3], and the contactless card 102 computes B=DES(ASKL) [B]. The contactless card 102 computes B=[B XOR T4], and the contactless card 102 computes B=DES(ASKL) [B]. The contactless card 102 computes B=DES⁻¹ (ASKR) [B], where DES⁻¹ is the reciprocal DES operation, and ASKR is a portion of the ASK, e.g., the right half. The contactless card 102 computes the cryptogram C=DES(ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3(DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹(DESK) [E1]. The device determines B=DES3⁻¹ (DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes) ∥Update Date Time (8 bytes) ∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

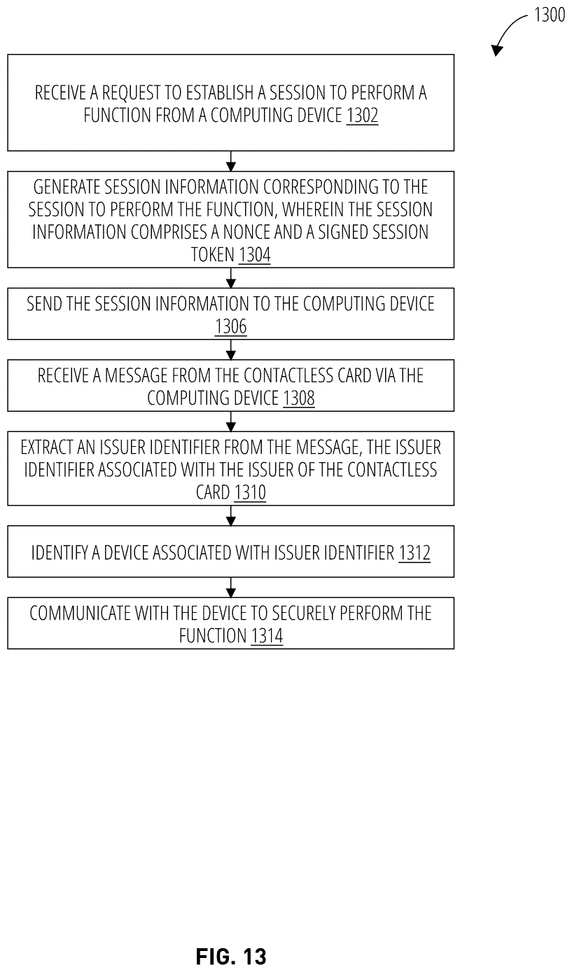

FIG. 13 illustrates an example of method 1300 in accordance with embodiments discussed herein. In block 1302, the method 1300 includes receiving, by a node in a system, a request to establish a session to perform a function from a computing device, wherein the function is at least partially performed utilizing a contactless card, such as contactless card 102. In some instances, the node may be one of a plurality nodes of a switchboard system. The node may be previously selected by the sending device via a DNS operation performed.

In block 1304, the method 1300 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1306, method 1300 includes sending the session information to the computing device by the node. The computing device may communicate with a contactless card to receive data from the card to authenticate and perform a function. In some instances, the computing device may send the nonce from the node to the contactless card. The contactless card may utilize the nonce when generating the message to communicate back to the computing device. Finally, the node, e.g., incorporates it into a cryptographic portion of the message (see FIG. 12).

In block 1308, method 1300 includes receiving, by the node, a message from the contactless card via the computing device. The message may be generated by the contactless card. FIG. 12 illustrates one example of a message 1200. In some embodiments, the node verifies the message. For example, the node may verify a nonce in the message and a signed session token.

In block 1310, method 1300 extracts an issuer identifier from the message by the node, the issuer identifier associated with the issuer of the contactless card. In some instances, the issuer identifier may be in a plaintext format.

In block 1312, method 1300 identifies, by the node, a device associated with the issuer identifier. For example, the node may perform a lookup to determine a server associated with the issuer identifier and the function to be performed.

In block 1314, method 1300 communicates, by the node, with the device to securely perform the function.

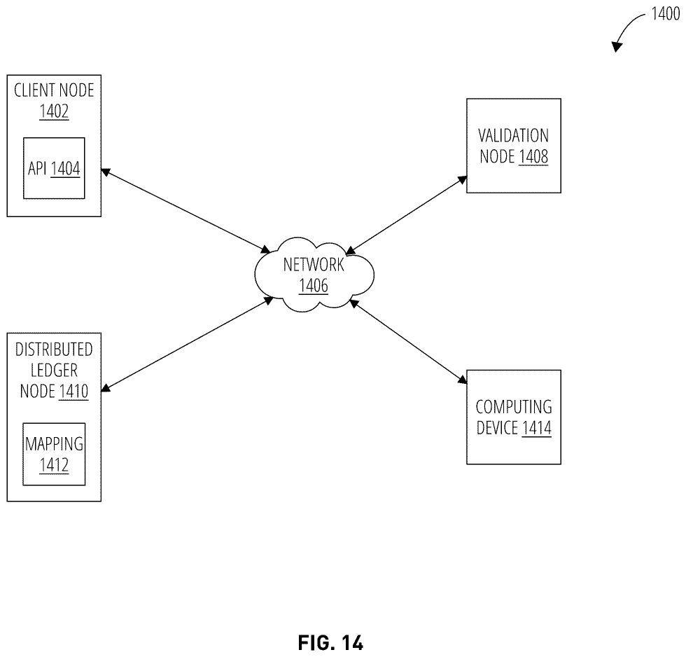

FIG. 14 illustrates a distributed network authentication system 1400 according to an example embodiment. As further discussed below, system 1400 can include client node 1402, API 1404, network 1406, distributed ledger node 1410, mapping 1412, and computing device 1414. Although FIG. 14 illustrates single instances of the components, system 1400 can include any number of components.

System 1400 can include a client node 1402, which can be a network-enabled computer as described herein. In some examples, client node 1402 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, client node 1402 can execute one or more applications, such as software applications, that enable, for example, network communications with one or more components of system 1400, transmit and/or receive data, and perform the functions and processes described herein.

The client node can contain an API 1404. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1404 to interact with the service, such as by performing a remote call to an API for interacting with a web-based service.

API 1404 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1402 can communicate with one or more other components of system 1400 either directly or via network 1406. Network 1406 can comprise one or more of a wireless network, a wired network or any combination of wireless network and wired network, and may be configured to connect the components of system 1400. While FIG. 14 illustrates communication between the components of system 1400 through network 1406, it is understood that any component of system 1400 can communicate directly with another component of system 1400, e.g., without involving network 1406.

System 1400 can include a validation node 1408, which can be a network-enabled computer as described herein. In some examples, validation node 1408 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, validation node 1408 can execute one or more applications, such as software applications, that enable, for example, network communications with one or more components of system 1400, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1400 can include a distributed ledger node 1410, which can be a network-enabled computer as described herein. In some examples, distributed ledger node 1410 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, distributed ledger node 1410 can execute one or more applications, such as software applications, that enable, for example, network communications with one or more components of system 1400, transmit and/or receive data, and perform the functions and processes described herein.

Distributed ledger node 1410 can containing a mapping 1412. In some examples, mapping 1412 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1400, or the one or more databases can be hosted externally to any component of the system 1400. In some examples, the one or more databases can be contained in the distributed ledger node 1410, and in other examples the one or more databases can be stored outside of distributed edger node 1410 but in data communication with distributed ledger node 1410. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1410. In other examples, the one or more databases can be remote from distributed ledger node 1410 but in data communication with distributed ledger node 1410. Data communication between the one or more databases and distributed ledger node 1410 can be a direct data communication or data communication via a network, such as the network 1406.

In some examples, client node 1402 can be in data communication with distributed ledger node 1410. Distributed ledger node 1410 can contain mapping 1412. Mapping 1414 may include, e.g., a mapping between a validation node address and the validation node 1408, a mapping between a routing number and a validation node address, and/or a mapping between a routing number and validation node 1408. In some examples, mapping 1412 can include a digital signature associated with an entity having permission to validate for a routing number. Based on one or more of these associations, client node 1402 can call validation node for validation and/or provide direction to the computing device to reach the appropriate validation node. This can be accomplished by calling a validation API associated with validation node 1408.

In some examples, iterations of the mappings described herein, such as mapping 1412, can also include a software or applet version number. The version number can be used to identify a validation node or validation node address or choose between multiple validation addresses for one validation node.

In some examples, client node 1402 and distributed ledger node 1410 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1410 can update mapping 1412 to reflect a different association between, e.g., a routing number, a validation node address, and a validation node. In some examples, degrees of permissions can be issued. For example, if client node 1402 were to function to route data to validation node 1408 (or other validation nodes), client node 1402 can be given a certain level of permissions. As another example, if distributed ledger node 1410 were to have the capability to update mapping 1412, distributed ledger node 1410 can have a different, higher level of permissions.

System 1400 can include a computing device 1414, which can be a network-enabled computer as described herein. In some examples, distributed ledger node 1414 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400. Computing device 1414 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, computing device 1414 can be in data communication with another network-enabled computer not shown in FIG. 14, such as a smart card (e.g., a contactless card or a contact-based card).

In some examples, computing device 1414 can execute one or more applications, such as software applications, that enable, for example, network communications with one or more components of system 1400, transmit and/or receive data, and perform the functions and processes described herein.

In some examples, upon receipt of an authentication request, computing device 1414 can call (e.g., via an API) client node 1402. The call can include a routing number and/or an applet or software version number, and client node 1402 can query distributed ledger node 1410 and mapping 1412. Once the query returns the identification of a validation node (e.g., validation node 1408) and/or a validation node address associated with that routing number and/or applet or software version, client node 1402 can reply to computing device 1414. Computing device 1414 can then proceed with authentication with the validation node. The authentication can be performed by, e.g., the systems and methods described herein, such as by the generation, encryption, transmission, decryption, and validation of a cryptogram as described herein.

In some examples, client node 1402 can be co-resident with validation node 1408. In these examples, client node 1402 can handle the authentication in a single call from computing device 1414. In some examples, this can be acceptable only if it is permissible for the full authentication transmission (e.g., a cryptogram as described herein) to be sent to client nodes that are not involved in authentication.

In some examples, if client node 1402 receives, from computing device 1414, a routing number that is not handled by its location, client node 1402 can return a code indicating that this routing number is not handled, along with validation node address for the responsible validation node. Computing device 1414 can then send the full authentication transmission to validation node 1408 using the received validation node address.

In some examples, client node 1402 can enter the distributed network with different permissions. For example, client node 1402 can be a read-only router of data. As another example, client node 1402 can have permission to send messages to distributed ledger node 1410 updating one or more routing paths for one or more routing numbers. However, client node 1402 would be prevented from updating one or more routing paths for one or more routing numbers for other entities that control other routing numbers which are not associated with client node 1402 or that did not grant this permission. As another example, distributed ledger node 1410 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or computing devices), add new signature credentials, add new keys, add new certifications, and also to revoke any of the foregoing. In some examples, the foregoing permissions can be delegated to client node 1402, distributed ledger node 1410, and/or validation node 1408, if security, legal, and/or financial conditions are met, however, delegation is not required.

In some examples, one or more APIs can facilitate communication between components of system 1400 via network 1406. In other examples, one or more APIs are not required. Rather, the components of system 1400 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1408 for authentication, can require storage of the keys in one or more HSMs, to promote key security and ensure that the keys are never entered into memory.

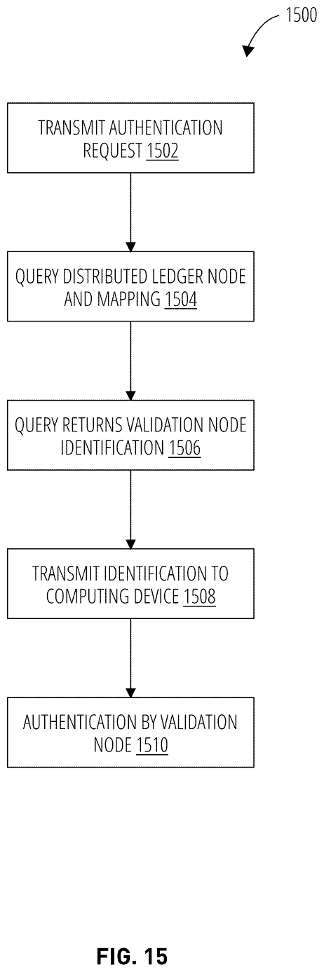

FIG. 15 illustrates a method 1500 performed by a distributed network authentication system according to an example embodiment. For example, the method can be performed by distributed network authentication system 1400 and or by another distributed network authentication system.

In block 1502, a computing device can transmit an authentication request to a client node. The authentication request can include, without limitation, a routing number, a software version number, and/or an applet version number. The request can be made by an API call or other communication between the computing device and the client node.

In block 1504, after receiving the authentication request, the client node can transmit a query (e.g., via an API call) to a distributed ledger node. The distributed ledger node contains a mapping, and the distributed ledger node can submit the query to the mapping.

In block 1506, the query can return an identification of a validation node and/or a validation node address, and the distributed ledger node can transmit this identification to the client node.

In block 1508, the client node can transmit the identification to the computing device. After receiving the identification, the computing device can proceed with authentication with the identified validation node and/or validation node address, in block 1510.

1. A method, comprising:
receiving, by an application executing on a processor of a first computing device associated with a first account and from a contactless card associated with a second account, an encrypted payload comprising identifying information of a second account;
sending, by the application, the encrypted payload to a server for authentication of the second account; and
receiving, by the application, verification of the second account and confirmation that the identifying information of the second account has been stored in association with a record of an event.

2. The method of claim 1, wherein the server requires a confirmation message from a second computing device associated with the second account before initiating authentication of the second account.

3. The method of claim 2, wherein the second computing device generates the confirmation message in response to tapping the contactless card to the second computing device.

4. The method of claim 1, further comprising sending, by the application to the server, identifying information of the first account, wherein the received confirmation from the server includes confirmation that the identifying information of the first account is stored in association with the record of the event.

5. The method of claim 1, wherein the first account comprises a first automobile insurance account associated with the first computing device, wherein the second account comprises a second automobile insurance account associated with the contactless card.

6. The method of claim 5, wherein the verification of the second account comprises verification of the second automobile insurance account, wherein the event comprises an automobile collision, the method further comprising receiving, by the application from the server, confirmation that the record of the automobile collision has been filed with an automobile insurance entity associated with the first account based on the identifying information of the first account and the identifying information of the second account.

7. The method of claim 5, further comprising receiving, by the application from the server, verifying attributes associated with the second account including at least one of a photograph of a driver associated with the second account, a name of the driver associated with the second account, a license plate number of a vehicle associated with the second account, and a make and model of the vehicle associated with the second account.

8. A non-transitory computer-readable storage medium, the computer-readable storage medium including instructions that when executed by a processor of a first computing device associated with a first account, cause the processor to:
receive, from a contactless card associated with a second account, an encrypted payload comprising identifying information of a second account;
send the encrypted payload to a server for authentication of the second account; and
receive verification of the second account and confirmation that the identifying information of the second account has been stored in association with a record of an event.

9. The computer-readable storage medium of claim 8, wherein the server requires a confirmation message from a second computing device associated with the second account before initiating authentication of the second account.

10. The computer-readable storage medium of claim 9, wherein the second computing device generates the confirmation message in response to tapping the contactless card to the second computing device.

11. The computer-readable storage medium of claim 8, wherein the instructions further cause the processor to send, to the server, identifying information of the first account, wherein the received confirmation from the server includes confirmation that the identifying information of the first account is stored in association with the record of the event.

12. The computer-readable storage medium of claim 8, wherein the first account comprises a first automobile insurance account associated with the first computing device, wherein the second account comprises a second automobile insurance account associated with the contactless card.

13. The computer-readable storage medium of claim 12, wherein the verification of the second account comprises verification of the second automobile insurance account, wherein the event comprises an automobile collision, wherein the instructions further cause the processor to receive, from the server, confirmation that the record of the automobile collision has been filed with an automobile insurance entity associated with the first account based on the identifying information of the first account and the identifying information of the second account.

14. The computer-readable storage medium of claim 12, wherein the instructions further cause the processor to receive, from the server, verifying attributes associated with the second account including at least one of a photograph of a driver associated with the second account, a name of the driver associated with the second account, a license plate number of a vehicle associated with the second account, and a make and model of the vehicle associated with the second account.

15. A computing device associated with a first account, the computing device comprising:
a processor;
a memory storing instructions that, when executed by the processor, cause the processor to:
receive, from a contactless card associated with a second account, an encrypted payload comprising identifying information of a second account;
send the encrypted payload to a server for authentication of the second account; and
receive verification of the second account and confirmation that the identifying information of the second account has been stored in association with a record of an event.

16. The computing device of claim 15, wherein the server requires a confirmation message from a second computing device associated with the second account before initiating authentication of the second account.

17. The computing device of claim 16, wherein the second computing device generates the confirmation message in response to tapping the contactless card to the second computing device.

18. The computing device of claim 15, wherein the instructions further cause the processor to send, to the server, identifying information of the first account, wherein the received confirmation from the server includes confirmation that the identifying information of the first account is stored in association with the record of the event.

19. The computing device of claim 15, wherein the first account comprises a first automobile insurance account associated with the first computing device, wherein the second account comprises a second automobile insurance account associated with the contactless card, wherein the verification of the second account comprises verification of the second automobile insurance account, wherein the event comprises an automobile collision, wherein the instructions further cause the processor to receive, from the server, confirmation that the record of the automobile collision has been filed with an automobile insurance entity associated with the first account based on the identifying information of the first account and the identifying information of the second account.

20. The computing device of claim 19, wherein the instructions further cause the processor to receive, from the server, verifying attributes associated with the second account including at least one of a photograph of a driver associated with the second account, a name of the driver associated with the second account, a license plate number of a vehicle associated with the second account, and a make and model of the vehicle associated with the second account.
